(19) United States
(12) Patent Application Publication
(10) Pub. No.: US 2023/0283688 A1
(43) Pub. Date: Sep. 7, 2023

(54) PUSH NOTIFICATION PERSISTENCE MANAGEMENT

(71) Applicant: Kyndryl, Inc., New York, NY (US)

(72) Inventors: Michael Seth SILVERSTEIN, Jacksonville, FL (US); Zachary A. SILVERSTEIN, Georgetown, TX (US); Jayanth KRISHNAN, Mahopac, NY (US); Krishnan SUGAVANAM, Mahopac, NY (US)

(21) Appl. No.: 17/685,597

(22) Filed: Mar. 3, 2022

(51) Int. Cl. H04L 67/55; G06F 3/01; G06F 3/04886

(52) U.S. Cl. CPC H04L 67/26; G06F 3/013; G06F 3/017; G06F 3/04886

(57) ABSTRACT

A computer-implemented method including: displaying, by a mobile device, a push notification from an application of the mobile device; determining, by the mobile device, an associated notification parameter for the push notification; receiving, by the mobile device, a user input by a user of the mobile device; determining, by the mobile device, the user input indicates interest in the push notification; and maintaining, by the mobile device, presence of the push notification on a display of the mobile device based on determining the user input indicates interest in the push notification and the associated notification parameter.

### BACKGROUND

Aspects of the present invention relate generally to push notifications and, more particularly, to a method and associated mobile device for improving push notification persistence based on user interest.

### SUMMARY

In a first aspect of the invention, there is a computer-implemented method including: displaying, by a mobile device, a push notification from an application of the mobile device; determining, by the mobile device, an associated notification parameter for the push notification; receiving, by the mobile device, a user input by a user of the mobile device; determining, by the mobile device, the user input indicates interest in the push notification; and maintaining, by the mobile device, presence of the push notification on a display of the mobile device based on determining the user input indicates interest in the push notification and the associated notification parameter.

In another aspect of the invention, there is a computer program product including one or more computer readable storage media having program instructions collectively stored on the one or more computer readable storage media. The program instructions are executable to: display a push notification from an application of the mobile device; determine an associated notification parameter for the push notification; receive a user input by a user of the mobile device; determine the user input indicates interest in the push notification; and maintain presence of the push notification on a display of the mobile device based on determining the user input indicates interest in the push notification and the associated notification parameter.

In another aspect of the invention, there is system including a processor, a computer readable memory, one or more computer readable storage media, and program instructions collectively stored on the one or more computer readable storage media. The program instructions are executable to: display a push notification from an application of the mobile device; determine an associated notification parameter for the push notification; receive a user input by a user of the mobile device; determine the user input indicates interest in the push notification; and maintain presence of the push notification on a display of the mobile device based on determining the user input indicates interest in the push notification and the associated notification parameter.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computer infrastructure according to an embodiment of the present invention.

FIG. 2 shows a block diagram of an exemplary environment in accordance with aspects of the invention.

FIG. 3 shows a flowchart of an exemplary method in accordance with aspects of the invention.

FIG. 4 shows a flowchart of another exemplary method in accordance with aspects of the invention.

FIG. 5 shows a top-down illustration of a non-limiting exemplary embodiment of a hand movement tracking and vectorization, as well as angle determination in accordance with aspects of the invention.

FIG. 6 shows another top-down illustration of a non-limiting exemplary embodiment of a hand movement tracking and vectorization, as well as angle determination in accordance with aspects of the invention.

### DETAILED DESCRIPTION

Aspects of the present invention relate generally to push notification persistence management and, more particularly, to push notification persistence. In embodiments, a mobile device (which may include smartphones, laptops, Internet of things (IoT) devices, and/or touchpads, for example) facilitates push notification management. In this manner, implementations of the invention provide push notification persistence based on user interest.

In embodiments, a computer-implemented method comprises integrating multiple enabling technologies (e.g., eye tracking, touch, audio, etc.) with a model to make notifications as useful as possible; and maintaining a notification (e.g., for a push notification such as a message), to stay displayed (e.g., making a notification sticky) based on user interaction (e.g., based on whether or not the user has seen the notification). In accordance with aspects of the invention, the model learns over time.

Implementations of the invention provide an improvement in the technical field of push notification management by providing a technical solution to the problem of push notification impermanence. In embodiments, the technical solution involves: displaying a push notification, determining push notification parameters for the displayed push notification, determining user interest for the push notification on a mobile device, and maintaining the push notification on the display of the mobile device based on the user interest and the push notification parameters. These steps allow the mobile device to better manage push notifications for a user's interests and more efficiently provide users with the push notifications they want and need to see.

Implementations of the invention utilize sensors and user inputs of the mobile device to determine user interest. When user interest is determined, the push notification is maintained on the display.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

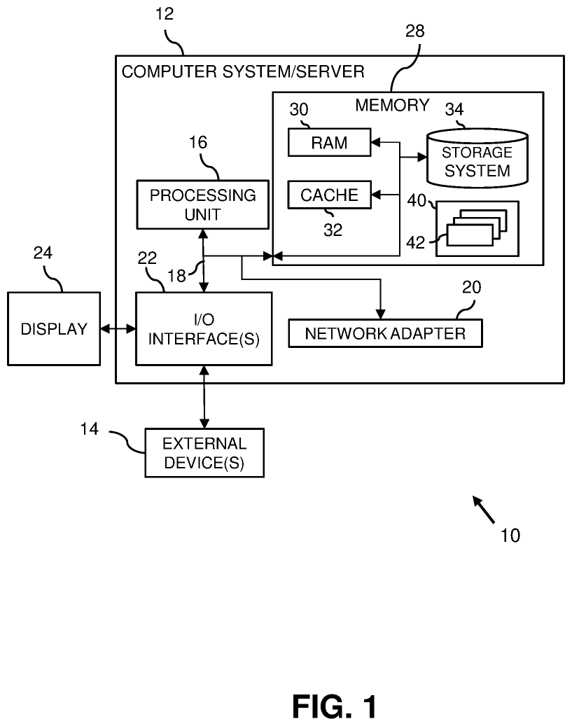

Referring now to FIG. 1, a schematic of an example of a computer infrastructure is shown. Computer infrastructure 10 is only one example of a suitable computer infrastructure and is not intended to suggest any limitation as to the scope of use or functionality of embodiments of the invention described herein. Regardless, computer infrastructure 10 is capable of being implemented and/or performing any of the functionality set forth hereinabove.

In computer infrastructure 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system executable instructions, such as program modules, being executed by a computer system. Generally, program modules may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system 12 in computer infrastructure 10 is shown in the form of a general-purpose computing device. The components of computer system 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

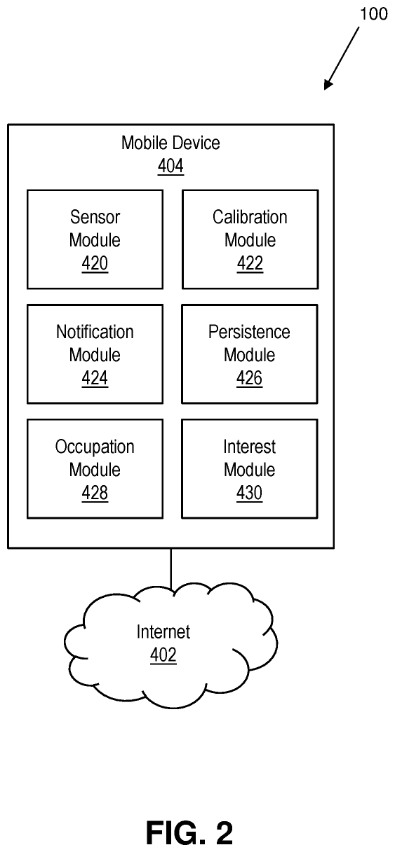

FIG. 2 shows a block diagram of an exemplary push notification persistence environment 100 in accordance with aspects of the invention. In embodiments, the environment 100 includes a mobile device 404 with a connection to the Internet 402 to send and receive push notifications for applications on the mobile device 404. In embodiments, the mobile device 404 comprises a user computing device such as a smartphone, laptop computer, Internet of things (JOT) device, smart watch, and tablet computer, and may comprise one or more elements of the computer system 12 of FIG. 1.

In embodiments, the mobile device 404 comprises a sensor module 420, a calibration module 422, a notification module 424, a persistence module 426, an occupation module 428, and an interest module 430, each of which may comprise one or more program modules such as program modules 42 described with respect to FIG. 1. The mobile device 404 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In the example of FIG. 2, the sensor module 420 is configured to collect sensor information from sensors of the mobile device 404. In implementations, these sensors may include a touchscreen, gyroscope, accelerometer, cameras, heart rate sensors, buttons, global positioning system (GPS), or other sensors that may be included in or connected to the mobile device 404. These sensors may be used to determine and calibrate for a user's input at the mobile device 404.

For example, the accelerometer and gyroscope may be used to determine that the mobile device 404 has been picked up or tilted. If another movement is not detected (e.g., returning the mobile device 404 to a resting position or un-tilted state) for a predetermined amount of time, the user is deemed to be more interested in the push notification. In embodiments, the predetermined amount of time that the mobile device 404 has been tilted or picked up indicates how interested the user is in the push notification. In one example, if the user is determined to have picked up or tilted the phone and put it down within one second, then the system deems that the user has little interest in the push notification. In this same example, if the user picks up or tilts the phone for longer than one second and less than two seconds, then the system deems that the user has moderate interest in the push notification. In this same example, if the user picks up or tilts the phone for longer than two seconds, then the system deems that the user has high interest in the push notification. Additionally, the length of the push notification may also be accounted for to determine interest. As applied to the same example, in embodiments, if the push notification is less than a few sentences long, the user has enough time to read the push notification within two seconds. Thus, any time shorter than half a second shows little interest, any time less than a second and more than half a second shows some interest, and any time greater than one second shows the user is very interested.

In another example, the mobile device 404 includes a display 24 and one or more cameras. In embodiments, the camera(s) are configured to track eye movement to determine a focus (i.e., gaze) of eye(s) of a user of the mobile device 404. In this example, the gaze of the user is mapped to the display 24 of the mobile device 404. The user may show more interest in the push notification based on a lingering gaze on the push notification, e.g., for more than a predefined length of time. For example, the user shows little interest if the gaze only flicks toward the notification and/or lingers for less than a second. In this same example, the user shows moderate interest if the gaze lingers for more than one second and less than two seconds. In this same example, the user shows high interest if the gaze lingers for more than two seconds.

In another example, the mobile device 404 includes a touchscreen or button sensing a touch by the user on the mobile device 404. The touch may include a touch to expand or minimize the size of the push notification on the screen or to keep the display 24 of the mobile device 404 active (i.e., out of a sleep mode). In embodiments, a touch to minimize a push notification or turn off the display 24 of the mobile device 404 indicates the shows no further interest in the push notification, whereas a touch to expand the push notification or keep the display 24 active indicates the user shows interest in the push notification. In other embodiments, the touchscreen is used to determine the pressure level of the user's touch which indicates interest, where a lighter pressure indicates less interest, and a greater pressure indicates more interest.

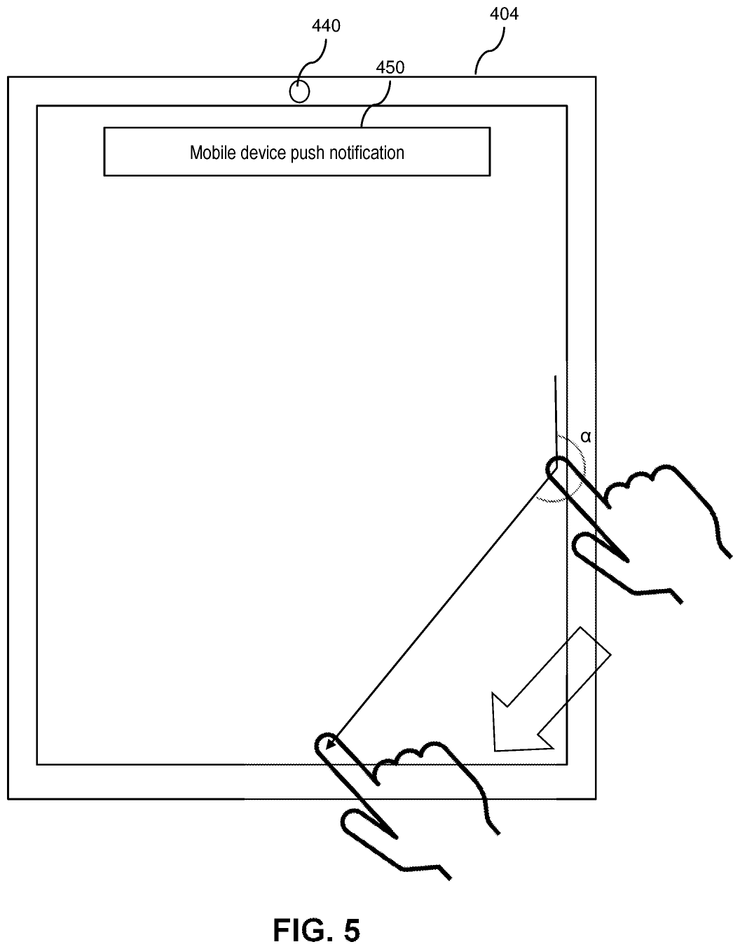

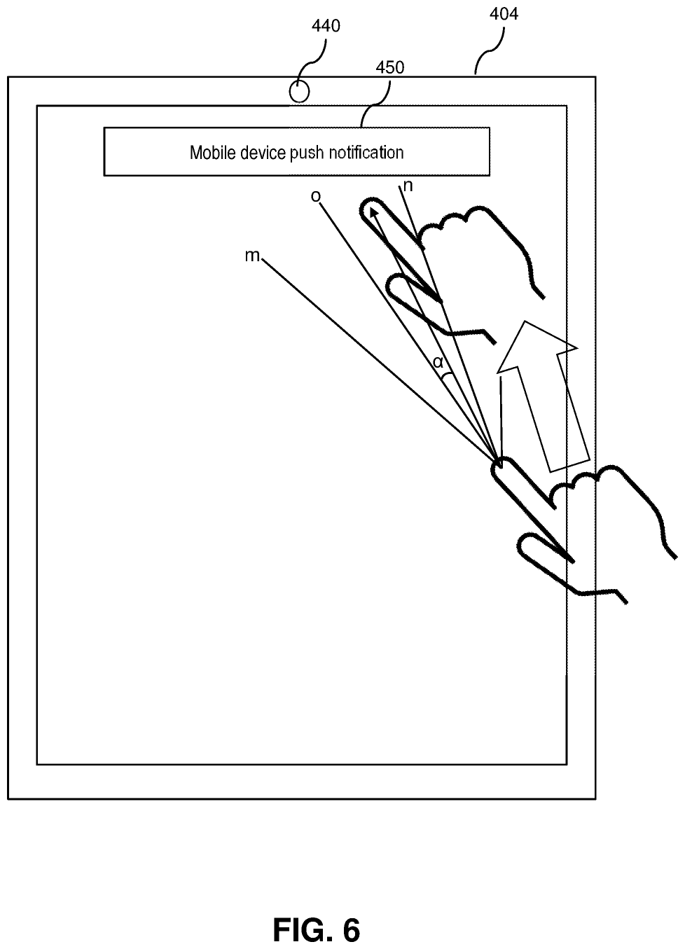

In another example, as shown in FIGS. 5 and 6, a camera 440 is configured to track hand movements. The camera 440 may take images of a hand or finger that is positioned over or in front of the mobile device 404 for analysis by the mobile device 404. In embodiments, the camera 440 detects the hand or finger above the device within a predefined amount time after the push notification is displayed. In embodiments, the system determines that the user is interested in the push notification when the hand or finger moves toward the push notification. For example, the system may identify a user's hand in the right side of a camera image and, as the hand moves toward the center of the image, the movement is vectorized by one or more points of the hand in the first image to the next image.

The vectorization (see, e.g., arrow line in FIGS. 5 and 6) shows the directionality of the movement and can be used to determine whether the user is showing interest in the push notification. In a non-limiting exemplary embodiment, as shown in FIG. 5, the directionality of the hand movement is from a right-center point in the first image to a bottom-center point in the second (e.g., later) image, and is between 180 and 225 degrees (assuming 0 degrees is from the bottom-center point toward the top-center point of the images, see angle α). In this example, the mobile device 404 determines that this directionality is not toward the push notification 450 which is at the top of the display in the mobile device 404. In other words, from the right-center point in the first image, a vectorized movement showing interest would have a directionality of between 300 and 330 degrees, e.g., toward the push notification instead of away from it. In embodiments, as shown in FIG. 6, the directionality is determined based on a 0 degree from initial point of the hand/finger toward a center point (coordinate) of the displayed push notification (represented by line o). Any vectorized movement should be within ±20 degrees of the 0 degree shown in FIG. 6 as the extremity coordinate points of the displayed push notification (represented by lines m and n). In embodiments, the directionality may include the extreme points of the displayed push notification, i.e., within a range of ±30 degrees, and also account for a 20-degree width from the extreme points of the displayed push notification. In embodiments, the same vectorization shown in FIGS. 5 and 6 may be used with eye tracking or cursor movement. For example, the same vectorization may be used for a cursor or eye tracking movement that replaces the hand movement shown in FIGS. 5 and 6.

In embodiments, the mobile device may determine interest by the user based on the user's hand hovering and moving toward the device. In a non-limiting exemplary embodiment, the hand movement from a right-center point in a first image toward a center point in the second image shows the user is interested based on their hand or finger moving toward the mobile device.

In another example, the mobile device 404 includes a heart rate monitor that tracks the user's heart rate as they look at the push notification. In this example, the system determines the user shows little or no interest in the push notification when the user's heart rate remains the same. In this example, the system determines the user shows moderate interest in the push notification when the user's heart rate increases by a first predefined amount (e.g., 5-20 beats per minute (bpm) increase). In this example, the system determines the user shows high interest in the push notification when the user's heart rate increases by a second predefined amount greater than the first predefined amount.

In embodiments, the calibration module 422 is configured to determine a baseline for what the mobile device 404 is sensing. For example, in embodiments, the front facing camera of a mobile device 404 may be calibrated to track focus of the user's eye(s). This calibration may account for a distance at which a user is reading the display 24 of the mobile device 404 and is used to identify what a user's eye(s) looks like when focused on the edges, center, and/or other particular positions on the display 24 (e.g., quadrants or particular locations of the display 24) of the mobile device 404. Thus, the calibration allows the mobile device 404 to capture the location(s) where the user's gaze is focused on the display 24 and compare against where the push notification is displayed on the display 24.

Additional or alternative examples include, in embodiments, calibration of other sensors such as by collecting a baseline heart rate or a baseline touch pressure that is captured from the user. In one example, the baseline is of a resting heart rate for the user and a baseline touch pressure is a standard press by the user. Further, in embodiments, a resting state of the mobile device 404 is captured to calibrate and determine when the mobile device 404 has been tilted or moved.

In embodiments, the notification module 424 includes notification parameters for types of applications, applications, and/or groups or individuals associated with an application. For example, certain types of applications, such as communication related applications may be prioritized over a media application. Certain applications may be more important to a user as well. For example, if a user uses one email application for work and another for personal use, the user may prioritize the work email application over the personal use email application and any push notifications received from the work email application. Further, a group or individual messaging over a communication/messaging application may have a higher priority over other groups/individuals. For example, when a family member communicates with the user, their push notifications may be prioritized. In embodiments, the notification module 424 applies machine learning based on the push notification and historic notification parameters to predict a push notification priority (i.e., interest) and persistence time. The notification module 424 may then track predictions and compare them against the push notification priority and persistence time as indicated by the user historically to iteratively provide better predictions in line with the user's interest. In embodiments, historical tracking of data associated with a push notification priority includes user scheduling, notification user input priority, notification level, and/or other push notification parameters (see below) that affect the push notification priority.

Additionally, or alternatively, the notification module 424 is configured to include push notification parameters including a default persistence time, a notification level, a notification user input priority, a user input focus capture, a notification display location, and/or a user scheduling. In embodiments, the default persistence time of a push notification is based on the application, type of application, and/or group or individual within the application from which the push notification has originated. Greater priority push notifications have a longer default persistence time. For example, push notifications from prioritized applications may have a persistence of 20 seconds and push notifications from low priority applications may have a persistence of 2 seconds or less.

In embodiments, notifications include audio, haptic, and/or visual notifications. Different types of notifications may have different levels that may be used with different priorities of push notifications. For example, audio notification levels may include softer or louder tones, or may use particular ring tones/songs. Haptic notification levels may include weaker, stronger, or patterned vibrations. Visual notification levels may include a folded or unfolded (i.e., minimized or expanded) notification message state, and may include lights on a mobile device 404. Thus, folded notifications may be used for lower priority push notifications and unfolded notifications may be used for higher priority push notifications. In embodiments, folded notifications are used when many notifications from the same application are received and displayed.

In embodiments, a notification user input priority allows users to set their own priority for particular applications, types of applications or groups/individuals in an application. For example, a user may want to prioritize notifications for deals from a deal finding application over everyday communication applications.

In embodiments, a user input focus capture includes a time that the notification needs to retain the user's focus to be considered important or of interest to the user. For example, when the mobile device 404 receives a push notification, the push notification is shown over a default amount of time (i.e., the default persistence time). To maintain the push notification on the display 24 or maintain the push notification in an unfolded (i.e., expanded) state, the timer for the default amount of time is reset based on a threshold captured focus time. In other words, when a threshold time of the user focusing on the push notification is met, the push notification default amount of time is reset. In embodiments, the system is configured to reset the push notification timer for displaying a particular push notification in response to the push notification being displayed and the system determining the user focusses on the push notification for more than a threshold captured focus time (e.g., a quarter second or longer). For example, the default amount of time to show a push notification may be set at five seconds. In this example, a push notification will disappear after being displayed for five seconds if the user does not look at the push notification for a duration of time equal to or greater than the threshold captured focus time. However, if the user does look at the push notification for a duration of time equal to or greater than the threshold captured focus time, then the system resets the timer and displays the push notification for another five seconds.

In embodiments, when the user's focus is captured for more than a quarter second, the push notification time is extended even further as this further focus indicates greater interest from a default persistence time of five seconds to eight seconds. In embodiments, different applications may have different threshold captured focus times. For example, a work communication application may have a relatively lower threshold captured focus time, and a social media application may have a relatively higher threshold captured focus time. In this manner, the time required for the user to look at a push notification to reset the display timer may be different for different applications.

In embodiments, different occupation levels of a user may affect the threshold captured focus time. For instance, when the user is occupied, the threshold captured focus time may be relatively lower than when the user is unoccupied. For example, if the user is busy or occupied, a threshold captured focus time is reduced by 15% of the targeted time period to allow the persistence time to reset. In other words, the time of focus by the user on the push notification reduces from a quarter of a second to about a fifth of a second to indicate that the user is interested in the push notification. Further, in embodiments, the user occupation level may also affect push notification time. For instance, when the user is occupied, the push notification time may be relatively higher than when the user is unoccupied. For example, if the user is busy or occupied, the push notification time is extended by 50% to allow the user more time to check and focus on the push notification. For example, the push notification is shown for six seconds instead of four before the notification is removed from the display 24.

In embodiments, a notification display location includes a location or size of a push notification on the display 24 of the mobile device 404. Coordinates for the push notification are based on a size of the display of the mobile device 404. The coordinates are used for both the push notification location (including real estate used in display 24) and the user input. The coordinates of the user input (both in a vectorized form and as a focused point) are compared to the push notification location coordinates to determine whether the user is interested in the push notification. Thus, when the user input coordinates are moving toward (in vectorized form) coordinates of the push notification (i.e., the notification display location), the vectorized movement indicates the user is interested in the push notification. When the user input coordinate is directed toward at least one coordinate covered by the coordinates of the push notification (i.e., the user input is directed to a portion of the push notification), the vectorized movement indicates the user is interested in the push notification. In embodiments, push notification display location and size are based on prioritization. For example, prioritized push notifications may be displayed in the center of the display 24, may be displayed in an expanded state (i.e., with more information), or may take more space on the display 24. In embodiments, the mobile device 404 determines the notification display location coordinates in the display 24 since there may be many push notifications displayed at a same time.

In embodiments, particular user input may include a threshold distance that indicates user interest. For example, a threshold distance for a user input focus coordinate may be predetermined to allow the user to touch or gaze at or near (e.g., within a range of) the push notification. Meeting such a distance indicates the user's interest in the push notification. For example, a user touching or gazing at a location within a quarter of an inch from the push notification would indicate the user's interest in the push notification. In embodiments, the threshold distance is adjusted based on other displayed notifications. For example, the threshold distance may be reduced when other push notifications are displayed nearby to reduce confusion with which push notification the user is showing interest. In embodiments, a threshold directionality for vectorized coordinates is used in place of a threshold distance. For example, a user input with a vectorized directionality of anywhere between a 35-degree arc from a starting point toward the push notification would indicate interest. Yet, in other embodiments, this threshold directionality may be reduced when other push notifications are displayed nearby (e.g., from 35 degrees to 20 degrees).

In embodiments, the system utilizes the user's schedule to control types and/or levels of push notifications the user will receive while occupied. For example, for certain applications, the push notifications will be silenced based on a user's activity. For instance, when a user is determined to be in a business meeting from their schedule, the push notification is silenced. When the user is meeting with friends as determined from their schedule, the push notification may only be visually presented. When the user is not busy as determined from their schedule, the push notification may be presented both visually and include an audio notification. The user scheduling may include calendar data for the user, user location, user set busy status, and/or captured sensor information that indicates the user is in a meeting. For example, the mobile device 404 may capture sensor data that includes data suggesting a discussion is going on during business or work hours. Thus, the mobile device 404 will silence most push notifications except notifications of high interest.

In embodiments, the system utilizes the user's occupation level to determine user interest level in a push notification. For example, when the user is found to be busy or occupied and the user input shows the user is interested in the push notification, the interest level in the push notification is deemed to be high (i.e., very interested). When the user is found to be unoccupied and the user indicates a low interest level, the interest level in the push notification is deemed to be very low. When the user is found to be busy and has a low level of interest in the push notification, the interest level in the push notification is deemed to be at a medium level (i.e., some interest). When the user is found to be unoccupied and has a high level of interest in the push notification, the interest level in the push notification is deemed to be at a medium level (i.e., some interest).

In embodiments, the persistence module 426 is configured to maintain the push notification on the display of the mobile device 404 for an amount of time. This amount of time may include a predetermined amount of time, such as a default persistence time. In embodiments, the default persistence time is reset when user interest is shown. In embodiments, the default persistence time is disregarded when the user shows sufficient interest, with the result being the push notification is maintained indefinitely until the user removes the push notification. In embodiments, the persistence module 426 also changes the default persistence time to account for user interest in the push notification. For example, when a user consistently shows interest in push notifications the default persistence time may be increased. When a user consistently shows little interest in push notifications, the default persistence time may be decreased.

In embodiments, the occupation module 428 is configured to determine an occupation level of the user of the mobile device 404. For example, the occupation module 428 determines the user is in a meeting based on analyzing audio captured by the mobile device 404. In embodiments, the occupation module 428 is given access to user calendar application(s) to determine when the user is busy. In embodiments, the user interest and push notification persistence are determined based on the occupation level of the user as described above.

In embodiments, the interest module 430 is configured to determine user interest in a push notification. The interest module 430 may collect information from all the modules to determine the user interest in a push notification. As described above, each module may provide determinations on user interest and those determinations may be prioritized and weighted when determining an overall user interest in a particular push notification. In embodiments, information from some modules, such as the occupation module 428 will be weighted more heavily to show user interest. For example, sensing the user is walking or working out may be prioritized over an unoccupied schedule from a user's calendar. This walking or working out shows the user occupation level and thus requires a shorter user input focus capture time to indicate greater user interest.

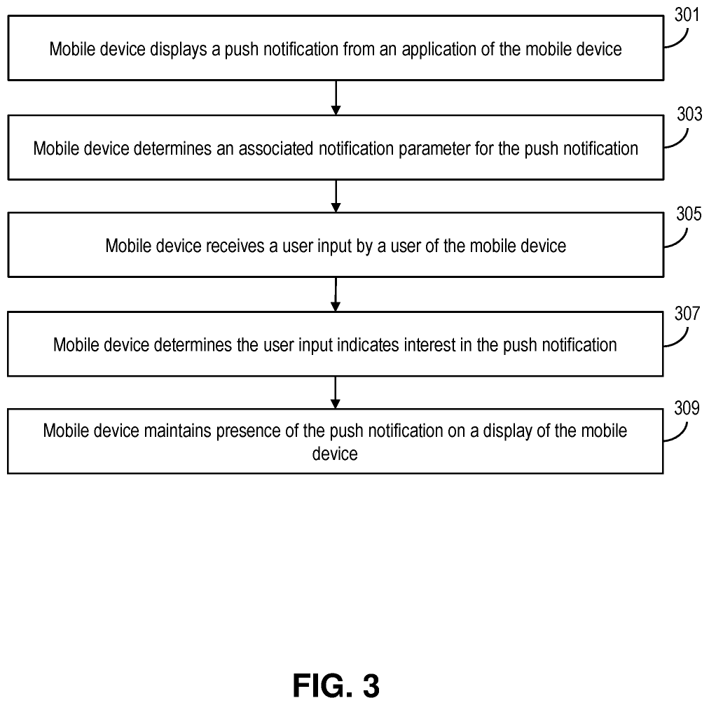

FIG. 3 shows a flowchart of an exemplary method in accordance with aspects of the present invention. Steps of the method may be carried out in the environment of FIG. 2 and are described with reference to elements depicted in FIG. 2.

At step 301, the mobile device 404 of FIG. 2 displays a push notification from an application of the mobile device 404. In aspects of the invention, the push notification is a displayed message. In embodiments, the push notification includes a visual message, visual light notification, audio notification, and/or haptic notification.

At step 303, the mobile device 404 of FIG. 2 determines an associated notification parameter for the push notification. In embodiments, the mobile device 404 compares the application, type of application, and/or group or individual of an application from which the push notification originates to a database of applications, types of applications, and/or groups or individuals of an application that includes associated push notification parameters. The push notification parameters are selected and applied based on identifying the of applications, types of applications, and/or groups or individuals of an application associated with the push notification. For example, particular applications will have higher priority than other applications and their push notifications will have longer persistence times, more obtrusive notification levels, and/or allow for shorter user input focus capture times. In embodiments, the associated notification parameter includes default persistence time, a notification level, a notification user input priority, a user input focus capture, a notification display location, and/or a user scheduling.

At step 305, the mobile device 404 of FIG. 2 receives a user input by a user of the mobile device 404. In embodiments, the user input includes hand hovering or gestures, eye tracking, mobile device movements, or touch or cursor input. In embodiments, the cursor input is received from a mouse, trackpad, or other device controlling a cursor of the mobile device 404. In embodiments, the mobile device 404 includes a camera, an accelerometer, a gyroscope, a touch sensitive display, cursor controls and/or other sensors such as heart rate sensors. The camera is used to capture both hand/finger hovering gestures or movements and/or eye tracking. These sensors capture the user input for further analysis in step 307. In embodiments, the mobile device 404 determines what user inputs are allowed to be captured based on what sensors are available to the mobile device 404 and/or user selection of user inputs. For example, a mobile device 404 may only have certain sensors such as a camera and gyroscope and not a touch pressure sensor.

In embodiments, to capture each user input, the mobile device 404 relies on different combinations of sensors or single sensors. For example, one combination may include the camera and accelerometer and/or gyroscope may be used to capture mobile device movements (e.g., to determine the mobile device 404 has been picked up or flipped over). In this case, the camera or ambient light sensor (ALS) includes a front view of the display 24 of the mobile device 404 that has changed from a dark to a light image, thus indicating the device has been flipped over. This data may be added to accelerometer or gyroscope sensor data to more accurately determine that the mobile device 404 has been flipped.

At step 307, the mobile device 404 of FIG. 2 determines the user input indicates interest in the push notification. In embodiments, the captured sensor data that includes the user input is analyzed to determine whether the user of the mobile device 404 is interested in the push notification. In embodiments, additional information may also be used to contribute to this interest determination as well as various combinations of each of the user inputs above, e.g., camera in combination with touchscreen inputs. In embodiments, levels of interest by the user are determined based on the analysis of the captured sensor data. In embodiments, a weighting of each user input indicates the user's interest level in the push notification by determining what user inputs are better indicators and weighting those user inputs more heavily. For example, a user's touch input on the push notification is more heavily weighted than a user's flipping the mobile device 404 over to glance at the push notification. Further, in embodiments, a history of the same or similar push notifications is tracked to provide previous interest in similar push notifications. A determination of similarity in push notifications includes the application type, application, group/individual of the application, length of push notification, etc. For example, push notifications from the same group/individual are likely to have the same interest by the user.

At step 309, the mobile device 404 of FIG. 2 maintains presence of the push notification on a display 24 of the mobile device 404. In embodiments, the mobile device 404 maintains the push notification on the display 24 of the mobile device 404 based on the determined interest by the user and the associated notification parameter. In embodiments, the mobile device 404 resets a push notification display timer based on the interest determination. For example, the default persistence time for a push notification may be five seconds. In this example, the push notification disappears after it has been displayed for five seconds. However, if the user shows interest in the push notification, the system resets the push notification display timer to five seconds such that the push notification is shown for an additional five seconds. In embodiments, the push notification is displayed until the user no longer shows interest. In embodiments, the push notification is displayed until the user dismisses the push notification by removing the display timer limitations. In embodiments, the push notification display timer is adjusted based on the level of interest shown. For example, in response to the system determining the user shows little interest, the system resets the timer to only one second. In this example, in response to the system determining the user shows moderate interest, the system resets the timer to five seconds. In this example, in response to the system determining the user shows high interest, the system resets the timer to ten seconds.

In embodiments, the associated notification parameter includes parameters that adjust how user interest is determined, such as, through notification user input priority, user input focus capture, and/or user scheduling. For example, certain user inputs may be prioritized, such as gaze information over a determination that the mobile device 404 has been flipped. In embodiments, the notification parameters change how the push notification presence is maintained, such as, through default persistence time, notification level, notification display location, and/or user scheduling parameters. For example, the push notification presence may be maintained with the default persistence time generally; however, when a user is occupied (as determined by their scheduling) the persistence time is increased.

In embodiments, for example, user interest is determined based on notification user input priority by prioritizing push notifications that originate from particular applications, types of applications, and groups/individuals in an application. In other words, particular applications may be prioritized over other applications. For example, a communication application is prioritized over a shopping application. In embodiments, for example, user interest is determined based on user input focus capture by adjusting a threshold time for which the user provides a focus on the push notification to indicate interest. A threshold time for user input focus capture may be reduced for prioritized applications or based on user occupation. In embodiments, for example, user interest is determined based on user scheduling. For example, an occupied user may indicate greater interest with less user input, thus user input focus capture time is reduced when occupied. In embodiments, the user interest is determined based on various combinations of these push notification parameters.

In embodiments, for example, push notification presence is maintained based on adjusting a default persistence time for particular applications, application types, and groups/individuals of an application. Prioritized applications have a default persistence time that is longer than less prioritized applications. In embodiments, for example, push notification presence is maintained based on a notification level for the particular applications, application types, and/or groups/individuals of an application. In these instances, prioritized applications may have higher notification levels providing a larger push notification size or obtrusive notifications (e.g., a lighting notification) initially. However, as a predetermined time passes, the real estate taken by the push notification on the display is reduced or obtrusiveness of notifications turned off after a predetermined time (e.g., lighting notifications are turned off). Additionally, or alternatively, the notification level may change based on occupation and user interest. For example, the notification level may be reduced from a normal notification level when the user is occupied. In another non-limiting exemplary embodiment, a normal notification level may include an expanded push notification and lights when the user is unoccupied but may include a folded push notification when the user is occupied. Additionally, the notification level may additionally or alternatively account for user interest. For example, greater user input/focus when a push notification is at a lower notification level shows greater interest and less user input/focus with a higher notification level shows less interest.

In embodiments, for example, push notification presence is maintained based on notification display location. For example, a maintained push notification may move to a different location on the display based on interest. A push notification that the user has shown some interest may be maintained in the center of the device until a push notification that is of higher interest is shown. A push notification of some interest is then moved to the extremities of the display, and the higher interest push notification maintained in the center. In embodiments, for example, push notification presence is maintained based on user scheduling. For example, when a user is determined to be occupied based on their scheduling the mobile device 404 may increase the time that the push notification is maintained on the display. When the user is occupied the push notification is maintained on the display for a longer amount of time or until just after the user is no longer occupied. When the user is unoccupied a push notification is maintained only by resetting the default persistence time.

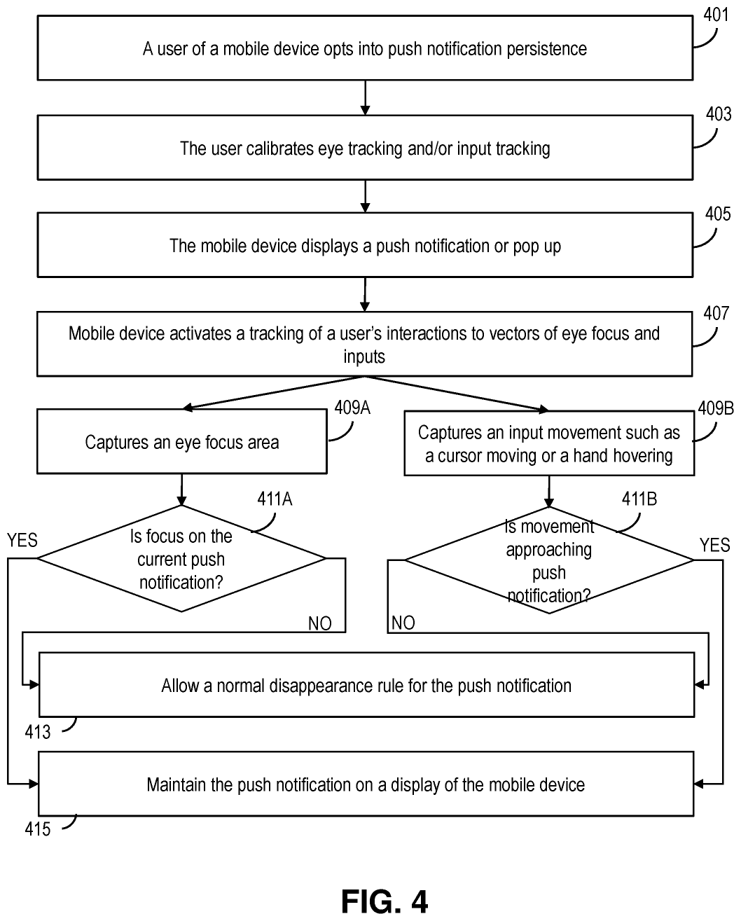

FIG. 4 shows a flowchart of an exemplary method in accordance with aspects of the present invention. Steps of the method may be carried out in the environment of FIG. 2 and are described with reference to elements depicted in FIG. 2.

At step 401, a user of the mobile device 404 of FIG. 2 opts-in to push notification persistence at the mobile device 404. In embodiments, the push notification persistence option is displayed to the user on the mobile device 404 and the user selects to opt-in or opt-out of the push notification persistence. The mobile device 404 receives the opt-in selection and push notification persistence is provided access to the mobile device 404 and its sensors, calendar data, etc.

At step 403, the user of the mobile device 404 of FIG. 2 calibrates eye tracking and/or input tracking. The user calibrates user input sensors of the mobile device 404 to capture user inputs from the user input sensors of the mobile device 404. For example, a front-facing camera of the mobile device 404 captures eye focus on locations of the display 24 of the mobile device 404. These user input focus locations are for a display coordinate of the mobile device 404 that is compared against coordinates for the push notification location (further accounting for the size of the push notification). The front-facing camera of the mobile device 404 may be used to capture hand gestures or movements to determine a vector in the direction of movement that corresponds to a push notification location. In embodiments, user input sensors may include the display 24 of the mobile device 404 that is a touchscreen that is configured to accept user touches. In embodiments, a user input includes a cursor or other selection method controlled by the user.

At step 405, the mobile device 404 of FIG. 2 receives a push notification or pop-up. The push notification or pop-up notification is displayed on the screen of the mobile device 404 and received from an application on the mobile device 404. The push notification is displayed in either a folded or expanded state. The push notification is folded or expanded based on previous interest by the user in notifications from the application, application notification settings established by the user, and how many notifications from the same application are currently displayed. For example, when multiple push notifications from the same application are displayed, only push notifications that would interest the user are maintained.

At step 407, the mobile device 404 of FIG. 2 activates a tracking of a user's interaction to vectors of eye focus and inputs. The sensors capture the user interactions as inputs (i.e., user inputs) and track the user inputs to determine movements and/or a vector of the user's movement and user input focus and map the focus and vectors to the display 24 of the mobile device 404 to determine if the movement is toward or away from the push notification. In particular, based on either the sensors of the mobile device 404, user selection, or the sensor data that is captured, the mobile device 404 captures eye focus or input movement. The sensors are activated and track any user interaction with the mobile device 404.

At step 409A, the mobile device 404 of FIG. 2 captures an eye focus area. The mobile device 404 determines the captured data is of the user's eye focus and maps the eye focus to the area of the display 24 of the mobile device 404.

At step 409B, the mobile device 404 of FIG. 2 captures an input movement such as a cursor moving or hand hovering. The mobile device 404 determines the captured data is of an input movement such as a cursor controlled by the user on the display 24 of the mobile device, or a hand hovering that is mapped to the area of the display 24 of the mobile device 404. The vectorized movement of the cursor or hand indicates a direction toward or away from the coordinates of the push notification.

At step 411A, the mobile device 404 of FIG. 2 determines whether the eye focus is on the current push notification. User interest is determined based on whether the eye focus is on coordinates of the push notification or has a vectorized movement toward or away from the coordinates of the push notification.

At step 411B, the mobile device 404 of FIG. 2 determines whether the vectorized movement of a hand or cursor is approaching the push notification. User interest is determined based on the vectorized movement, the mobile device 404 determines whether the movement is toward or away from the coordinates of the push notification.

At step 413, the mobile device 404 of FIG. 2 allows a normal disappearance rule (i.e., default persistence time) for the push notification. If the eyes are not focused on the current push notification or the user input movement vector does not approach the push notification, then the user is disinterested or less interested in the push notification and the push notification is removed in the default manner (e.g., using the default persistence time that removes the push notification after five seconds).

At step 415, the mobile device 404 of FIG. 2 maintains the push notification on a display 24 of the mobile device 404 by either resetting a default persistence time or maintaining the push notification until a user of the mobile device dismisses the push notification. If the eyes are focused on the current push notification or the user input movement vector approaches the push notification, then the user is interested in the push notification and the push notification is maintained on the display 24 of the mobile device 404.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, comprising:
displaying, by a mobile device, a push notification from an application of the mobile device;
determining, by the mobile device, an associated notification parameter for the push notification;
receiving, by the mobile device, a user input by a user of the mobile device;
determining, by the mobile device, the user input indicates interest in the push notification; and
maintaining, by the mobile device, presence of the push notification on a display of the mobile device based on determining the user input indicates interest in the push notification and the associated notification parameter, the associated notification parameter indicating priority of the push notification and wherein the associated notification parameter adjusts the indicated interest in the push notification.

2. The computer-implemented method of claim 1, wherein the user input is selected from the group consisting of eye tracking, device movement, cursor input, and hand input.

3. The computer-implemented method of claim 2, wherein the hand input includes hand hovering or touch input by the user of the mobile device.

4. The computer-implemented method of claim 2, wherein the eye tracking further comprises:
receiving and analyzing images from a camera of the mobile device that indicate a gaze of a user on a portion of the display of the mobile device.

5. The computer-implemented method of claim 2, wherein the cursor input or the hand input indicate an interest in the push notification based on cursor movement or hand movement toward or on a location of the display of the mobile device showing the push notification.

6. The computer-implemented method of claim 2, wherein the device movement includes movement from an at rest position of the mobile device for a predetermined time period.

7. The computer-implemented method of claim 1, wherein the associated notification parameter is selected from the group consisting of a default persistence time, a notification level, a notification user input priority, a user input focus capture, a notification display location, and a user scheduling; and the method further comprising:
changing the default persistence time based on the determining the user input indicates interest in the push notification.

8. The computer-implemented method of claim 7, further comprising:
identifying, by the mobile device, a user occupation level; and
adjusting, by the mobile device, the associated notification parameter based on the user occupation level.

9. The computer-implemented method of claim 1, further comprising:
calibrating, by the mobile device, a user input focus capture identifying the user input.

10. The computer-implemented method of claim 9, further comprising:
activating and tracking the user input in the user input focus capture based on receiving the push notification.

11. The computer-implemented method of claim 1, further comprising:
activating and tracking the user input in a user input focus capture that identifies the user input based on the associated notification parameter.

12. The computer-implemented method of claim 1, wherein the determining whether the user input indicates interest in the push notification further comprises:
determining, by the mobile device, the user input is directed toward a displayed location of the push notification on the mobile device.

13. The computer-implemented method of claim 1, wherein the interest in the push notification is determined based on the user input and a user occupation level; and the method further comprising:
predicting the priority and a persistence time of the push notification based on historic notification parameters.

14. A computer program product comprising one or more computer readable storage media having program instructions collectively stored on the one or more computer readable storage media, the program instructions executable to:
display a push notification from an application of a mobile device;
determine an associated notification parameter for the push notification, wherein the associated notification parameter being based on at least one of a type of the application, the application, and group or individual associated with the application;
receiving a user input by a user of the mobile device;
determine the user input indicates interest in the push notification; and
maintain presence of the push notification on a display of the mobile device based on determining the user input indicates interest in the push notification and the associated notification parameter.

15. The computer program product of claim 14, wherein the associated notification parameter is further selected from the group consisting of a default persistence time, a notification level, a notification user input priority, a user input focus capture, a notification display location, and a user scheduling; and wherein the program instructions are further executable to:
change the default persistence time based on the determining the user input indicates interest in the push notification

16. The computer program product of claim 15, wherein the program instructions are executable to:
identify a user occupation level; and
adjust the associated notification parameter based on the user occupation level.

17. The computer program product of claim 14, wherein the program instructions are executable to:
calibrate a user input focus capture that identifies the user input.

18. The computer program product of claim 17, wherein the program instructions are executable to:
activate and track the user input in the user input focus capture based on receiving the push notification.

19. A system comprising:
a processor, a computer readable memory, one or more computer readable storage media, and program instructions collectively stored on the one or more computer readable storage media, the program instructions executable to:
receive an opt-in selection by a user of a mobile device;
calibrate user input sensors of the mobile device;
display a push notification from an application of the mobile device;
track a user input from the user input sensors of the mobile device;
based on the user input, determine the user input is focused on the push notification or approaches the push notification indicating interest in the push notification; and
maintain presence of the push notification on a display of the mobile device based on determining the user input indicates interest in the push notification and an associated notification parameter of the push notification, the associated notification parameter being based on at least one of a type of the application, the application, and a group or individual associated with the application, and wherein the associated notification parameter adjusts the indicated interest in the push notification.

20. The system of claim 19, wherein the program instructions are executable to:
determine an associated notification parameter for the push notification, wherein the presence of the push notification on the display is maintained based on interest and the associated notification parameter that is further selected from the group consisting of a default persistence time, a notification level, a notification user input priority, a user input focus capture, a notification display location, and a user scheduling; and
change the default persistence time based on the determining the user input indicates interest in the push notification.
